(19) United States
(12) Patent Application Publication
(10) Pub. No.: US 2026/0172881 A1
(43) Pub. Date: Jun. 18, 2026

(54) METHOD AND APPARATUS FOR TRANSMITTING AND RECEIVING INFORMATION

(71) Applicant: 1FINITY Inc., Kawasaki-shi (JP)

(72) Inventors: Yujia SHAN, Beijing (CN); Xin WANG, Beijing (CN); Meiyi JIA, Beijing (CN); Guorong LI, Beijing (CN)

(73) Assignee: 1FINITY Inc., Kawasaki-shi (JP)

(21) Appl. No.: 19/534,169

(22) Filed: Feb. 9, 2026

Related U.S. Application Data
(63) Continuation of application No. PCT/CN2023/112396, filed on Aug. 10, 2023.

(51) Int. Cl. H04W 24/10; H04L 41/16

(52) U.S. Cl. CPC H04W 24/10; H04L 41/16

(57) ABSTRACT

An apparatus for transmitting and receiving information, configured in a first network device, includes: a generator configured to generate second configuration information according to first configuration information and first information and/or second information, the second configuration information being used to configure measurement and data reporting of a terminal equipment, the first configuration information and the first information being from a second network device, and the second information being from the terminal equipment; and a first transmitter configured to transmit the second configuration information to the terminal equipment.

### CROSS-REFERENCE TO RELATED APPLICATION

This application is a continuation application under 35 U.S.C. 111(a) of International Patent Application PCT/CN2023/112396 filed on Aug. 10, 2023, and designated the U.S., the entire contents of which are incorporated herein by reference.

### TECHNICAL FIELD

This disclosure relates to the field of communication technologies.

### BACKGROUND

With the commercialization of 5G technology, especially following the large-scale deployment of the industrial internet industry, in the field of wireless communications, there are many use cases of using AI (artificial intelligence) and ML (machine learning) algorithms to improve performance, such as using AI for CSI (channel state information) compression feedback, beam management, and wireless positioning, etc.

Currently, artificial intelligence algorithms represented by deep learning require collection of large amounts of data at various stages of their lifecycle, such as model training, inference, supervision, and switching. In wireless communications, such data are usually some physical measurement quantities in wireless channels, and need to be obtained by channel measurement reporting between base stations and terminal equipments (UEs).

The collection and reporting of wireless data may be applied in many scenarios and use cases. For example, in a current 3GPP wireless framework, there exists a minimization of drive test (MDT) scheme, in which a UE may online collect channel measurement data via signaling configured by a base station (gNB) in a connected state, or an idle state or an inactive state, such as channel quality (such as RSRP, and an RSSI, etc.) and UE position (such as latitude and longitude coordinates). The collected data may be stored in a form of a log and reported uniformly to the base station at a certain time; or, the collected data may be reported to the base station on-demand via signaling. A mode of reporting may be configured via RRC signaling, and after receiving the data reported by the UE, the base station may report the data to a core network.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In current collection and reporting of wireless data, a scope of data collection may be specified and implemented by configuring messages.

Taking MDT as an example, in the current 3GPP standard, MDT may specify the scope of data collection and implement it in two MDT configuration methods, one is to limit the scope of data collection by specifying an area. For example, an area scope parameter in LTE and NR are defined as follows:

The Area Scope parameter in LTE and NR is either:
list of Cells, identified by E-UTRAN-CGI or NG-RAN CGL. Maximum 32 CGI can be defined.
List of Tracking Area, identified by TAC. Maximum of 8 TAC can be defined.
List of Tracking Area Identity, identified by TAC with associated plmn-Identity perTAC-List containing the PLMN identity for each TAC. Maximum of 8 TAI can be defined. For further details see also TS 3.331[32].
The other is to specify the UE to participate in MDT data collection and reporting via user or equipment information, such as IMSI (international mobile subscriber identity)/IMEI (international mobile equipment identity).

However, it was found by the inventors that neither of the above configuration methods is able to meet precise and flexible configuration requirements for data collection in such application scenarios as AI/ML, etc. For example, for the first configuration method, the above three sub-options are applications based on a concept of cell or tracking area (with a scope greater than that of the cell) for AI/ML applications, especially applications of wireless positioning. The area scope of such a level is too large to effectively support fine discrimination for AI/ML data collection. For the second configuration method, the IMSI/IMEI as UE equipment information is unable to be directly associated with data collection requirements of AI/ML applications, and using of the equipment information is unable to effectively define the scope of data collection for the AI/ML applications.

In order to solve one or more of the above problems, embodiments of this disclosure provide a method and apparatus for transmitting and receiving information.

According to a first aspect of the embodiments of this disclosure, there is provided a method for transmitting and receiving information, the method including: generating second configuration information by a first network device according to first configuration information and first information and/or second information, the second configuration information being used to configure measurement and data reporting of a terminal equipment, the first configuration information and the first information being from a second network device, and the second information being from the terminal equipment; and transmitting the second configuration information by the first network device to the terminal equipment.

According to a second aspect of the embodiments of this disclosure, there is provided a method for transmitting and receiving information, the method including: receiving second configuration information by a terminal equipment from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and executing a measurement and data reporting procedure by the terminal equipment according to the second configuration information.

According to a third aspect of the embodiments of this disclosure, there is provided a method for transmitting and receiving information, the method including: transmitting first configuration information by a second network device to a first network device, so that the first network device generates second configuration information according to the first configuration information and first information and/or second information, the second configuration information being used to configure measurement and data reporting of a terminal equipment, the first configuration information and the first information being from the second network device, and the second information being from the terminal equipment.

According to a fourth aspect of the embodiments of this disclosure, there is provided an apparatus for transmitting and receiving information, configured in a first network device, the apparatus including: a generating unit configured to generate second configuration information according to first configuration information and first information and/or second information, the second configuration information being used to configure measurement and data reporting of a terminal equipment, the first configuration information and the first information being from a second network device, and the second information being from the terminal equipment; and a first transmitting unit configured to transmit the second configuration information to the terminal equipment.

According to a fifth aspect of the embodiments of this disclosure, there is provided an apparatus for transmitting and receiving information, configured in a terminal equipment, the apparatus including: a receiving unit configured to receive second configuration information from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and a measurement and reporting unit configured to execute a measurement and data reporting procedure according to the second configuration information.

According to a sixth aspect of the embodiments of this disclosure, there is provided an apparatus for transmitting and receiving information, configured in a second network device, the apparatus including: a second transmitting unit configured to transmit first configuration information to a first network device, so that the first network device generates second configuration information according to the first configuration information and first information and/or second information, the second configuration information being used to configure measurement and data reporting of a terminal equipment, the first configuration information and the first information being from the second network device, and the second information being from the terminal equipment.

According to a seventh aspect of the embodiments of this disclosure, there is provided a computer readable program, which, when executed in an apparatus for transmitting and receiving information or a first network device, will cause the apparatus for transmitting and receiving information or the first network device to implement the method for transmitting and receiving information as described in the embodiment of the first aspect of this disclosure.

According to an eighth aspect of the embodiments of this disclosure, there is provided a computer readable program, which, when executed in an apparatus for transmitting and receiving information or a terminal equipment, will cause the apparatus for transmitting and receiving information or the terminal equipment to implement the method for transmitting and receiving information as described in the embodiment of the second aspect of this disclosure.

According to a ninth aspect of the embodiments of this disclosure, there is provided a computer readable program, which, when executed in an apparatus for transmitting and receiving information or a second network device, will cause the apparatus for transmitting and receiving information or the second network device to implement the method for transmitting and receiving information as described in the embodiment of the third aspect of this disclosure.

According to a tenth aspect of the embodiments of this disclosure, there is provided a computer readable medium, including a computer readable program, which will cause an apparatus for transmitting and receiving information or a first network device to implement the method for transmitting and receiving information as described in the embodiment of the first aspect of this disclosure.

According to an eleventh aspect of the embodiments of this disclosure, there is provided a computer readable medium, including a computer readable program, which will cause an apparatus for transmitting and receiving information or a terminal equipment to implement the method for transmitting and receiving information as described in the embodiment of the second aspect of this disclosure.

According to a twelfth aspect of the embodiments of this disclosure, there is provided a computer readable medium, including a computer readable program, which will cause an apparatus for transmitting and receiving information or a second network device to implement the method for transmitting and receiving information as described in the embodiment of the third aspect of this disclosure.

An advantage of the embodiments of this disclosure exists in that,
according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of the embodiments of this disclosure;

FIG. 2 is a schematic diagram of a method for transmitting and receiving information of the embodiments of this disclosure;

FIG. 3 is a block diagram of an implementation of the method for transmitting and receiving information of the embodiments of this disclosure;

FIG. 4 is an interaction diagram of an implementation of the method for transmitting and receiving information of the embodiments of this disclosure;

FIG. 5 is a block diagram of another implementation of the method for transmitting and receiving information of the embodiments of this disclosure;

FIG. 6 is an interaction diagram of another implementation of the method for transmitting and receiving information of the embodiments of this disclosure;

FIG. 7 is an interaction diagram of a further implementation of the method for transmitting and receiving information of the embodiments of this disclosure;

FIG. 8 is another schematic diagram of the method for transmitting and receiving information of the embodiments of this disclosure;

FIG. 9 is a further schematic diagram of the method for transmitting and receiving information of the embodiments of this disclosure;

FIG. 10 is a schematic diagram of an apparatus for transmitting and receiving information of the embodiments of this disclosure;

FIG. 11 is another schematic diagram of the apparatus for transmitting and receiving information of the embodiments of this disclosure;

FIG. 12 is a further schematic diagram of the apparatus for transmitting and receiving information of the embodiments of this disclosure;

FIG. 13 is a block diagram of a systematic structure of a first network device of the embodiments of this disclosure;

FIG. 14 is a block diagram of a systematic structure of a terminal equipment of the embodiments of this disclosure; and

FIG. 15 is a block diagram of a systematic structure of a second network device of the embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB CU and one or more gNB DUs, wherein the CU/DU is a logical node of the gNB having a part of functions of the gNB. And a term “cell” may refer to a base station and/or its coverage area, depending on a context of the term.

In the embodiments of this disclosure, ‘a network device’ may further include a network device or a network element of a core network and/or a higher-layer network. For example, the core network includes an EPC (corresponding to a 4G core network) and/or a 5GC (corresponding to a 5G core network).

The EPC includes but is not limited to the following network elements: an MME(mobility management entity), an SGW (serving gateway), a PGW(PDN gateway), and a PCRF (policy and charging rules function), etc.

The 5GC includes but is not limited to the following network elements: an AMF (access and mobility management function), an LMF (location management function), an SMF (session management function), a UPF (user plane function), a PCF (policy control function), UDM (unified data management), an AUSF (authentication server function), and a UDR (unified data repository), etc.

In the embodiments of this disclosure, the term “user equipment (UE)” or “a terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” in this text may refer to a network device, and may also refer to a terminal equipment.

Scenarios of the embodiments of this disclosure shall be described below by way of examples; however, this disclosure is not limited thereto.

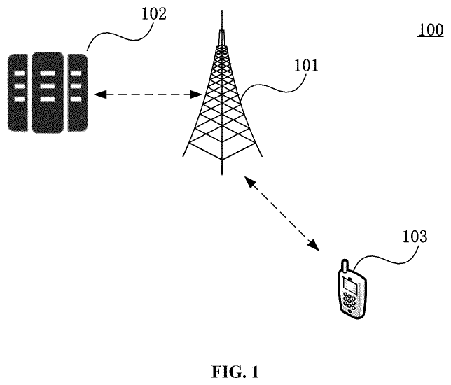

FIG. 1 is a schematic diagram of a communication system of this disclosure. As shown in FIG. 1, a communication system 100 may include a first network device 101, a second network device 102 and a terminal equipment 103. For the sake of simplicity, an example having only one terminal equipment and one network device is schematically given in FIG. 1; however, the embodiments of this disclosure are not limited thereto.

In the embodiments of this disclosure, the first network device 101 is, for example, a base station, such as a gNB.

The second network device 102 is, for example, one or more network devices or network elements of a core network and/or a higher-layer network.

In the embodiments of this disclosure, existing services or services that may be implemented in the future may be performed between the network device 101 and the terminal equipment 102. For example, such services may include but not limited to an enhanced mobile broadband (eMBB), massive machine type communication (MTC), and ultra-reliable and low-latency communication (URLLC), etc.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or a MAC control element (MAC CE); however, this disclosure is not limited thereto.

### Embodiment of a First Aspect

The embodiments of this disclosure provide a method for transmitting and receiving information, which shall be described from a first network device side.

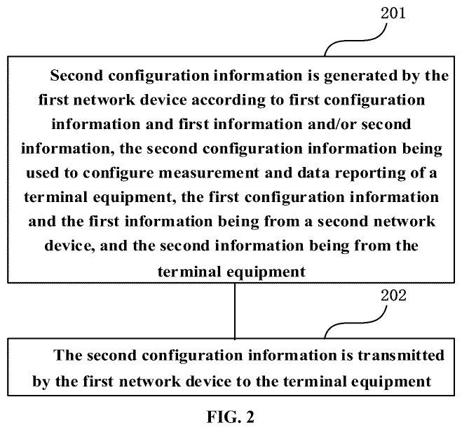

FIG. 2 is a schematic diagram of the method for transmitting and receiving information of the embodiments of this disclosure. As shown in FIG. 2, the method includes:
201: second configuration information is generated by the first network device according to first configuration information and first information and/or second information, the second configuration information being used to configure measurement and data reporting of a terminal equipment, the first configuration information and the first information being from a second network device, and the second information being from the terminal equipment; and
202: the second configuration information is transmitted by the first network device to the terminal equipment.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In addition, the method for transmitting and receiving information of the embodiments of this disclosure may be applicable to various scenarios and use cases that require data collection, such as used for MDT; however, this disclosure is not limited to such scenarios.

In operation 201, the first network device generates the second configuration information according to the first configuration information and the first information and/or the second information, that is,
the first network device generates the second configuration information according to the first configuration information and the first information received from the second network device, or,
the first network device generates the second configuration information according to the first configuration information and the second information received from the terminal equipment, or
the first network device generates the second configuration information according to the first configuration information and the first information received from the second network device and the second information received from the terminal equipment.

The first configuration information, the first information and the second information in operation 201 shall be described below in detail.

In some embodiments, first, the first network device receives the first configuration information from the second network device, for example, a base station receives the first configuration information from a core network and/or higher-layer network.

In some embodiments, the first configuration information is minimization of drive test (MDT) configuration information. In addition, the first configuration information may also be configuration information in other scenarios or use cases that require data collection; however, the embodiments of this disclosure are not limited thereto.

For example, the first configuration information may be carried by TRACE activation signaling containing MDT configuration information, the TRACE activation signaling being transmitted to the first network device by a management system in the second network device. A configuration mode of the MDT configuration information may a management-based MDT configuration mode, or may be a signaling-based MDT configuration mode. For example, detailed contents of the signaling are defined in TS32.422.

In addition, the MDT configuration information in the embodiments of this disclosure is not limited to 5GNR and is also applicable to other RAT technologies. The first configuration information may further include MDT configurations and other related information defined in protocols, such as TS32.422, TS37.320, and TS38.331, etc.

In some embodiments, the first network device further receives the first information from the second network device.

In some embodiments, a transmission mode of the first information includes at least one of the following that: as an optional part of the first configuration information, the first information is transmitted along with the first configuration information; and the first information is transmitted via NGAP signaling and/or other signaling, and not transmitted along with the first configuration information. That is, the first information may be transmitted along with the first configuration information, or may be transmitted separately from the first configuration information.

In some embodiments, the first information is related to a data collection scope, for example, the first information is first scope information and/or second scope information.

In some embodiments, the first scope information indicates an area and/or a zone and/or a region where a data collection procedure is performed.

In some embodiments, the area (or zone) is a part of an area scope, and includes a part less than or equal to a cell;
or, the area (or zone) is a part of multiple area scopes;
or, the area (or zone) is all of one or more area scopes.

For example, the area is all or a part of one or more existing area scopes, and a magnitude of the area comprises a magnitude less than that of a cell.

Therefore, based on the first information, data collection may be configured more finely. For example, there may exist M areas in a cell according differences in characteristics of wireless channels. For an application sensitive to channel characteristics, such as an AI/ML wireless positioning model, data collected only in N (N≤M) areas are effective for the model.

In some embodiments, the first scope information is an area identifier (e.g. an area ID or a zone ID) and/or a scene identifier or scenario identifier (e.g. a scene ID or a scenario ID).

The area identifier of the embodiments of this disclosure may be represented in various ways.

For example, integers may be used as identifiers, such as area identifiers 1, 2, 3 . . . ;
for another example, bitmaps may be used as identifier, for example, a bitmap of N bits may be used to indicate N areas, and the value of N may be determined as actually demanded, for example, N is equal to 8. When a bitmap method is used, more than one areas may be specified simultaneously;
for a further example, an area may be defined in other ways. In some embodiments, an area identifier may be accompanied with area specifying assistance information, such as one or more coordinates, or a radius, etc.

In some embodiments, the area identifier may have multiple levels, such as first level area identifiers 1, 2, 3, . . . indicating a relatively large scope of areas, each first level area identifier containing one or more second level area identifiers, and the scope indicated by the second level area identifiers being not greater than that of the first level area identifiers.

In some embodiments, the area indicated by the area identifier may be used independently from or jointly with existing defined areas and/or regions;
in some embodiments, in specifically indicating a scope of an area, an existing defined cell or Location Area or Tracking Area may be used to indicate a relatively large scope, and an area identifier is used to indicate a relatively small area.

In some embodiments, the area identifier includes a first area identifier and a second area identifier, the first area identifier corresponding to a first area, and the second area identifier corresponding to a second area.

The first area and the second area are different from each other, that is, areas indicated by different area identifiers are different from each other. For example, areas indicated by area identifier 1 and area identifier 3 are different from each other.

In some embodiments, bearer signaling of the area identifier may be an optional part of configuration signaling of the MDT;
in some embodiments, the bearer signaling of the area identifier may be an optional part of other configuration signaling of the MDT;
in some embodiments, the bearer signaling of the area identifier may be an optional part of TRACE-related signaling;
in some embodiments, when the second network device is a location management function module (LMF), the bearer signaling of the area identifier may be an optional part of NRPPa-related signaling.

In some embodiments, the bearer signaling of the area identifier may be other signaling or a part of other signaling.

In some embodiments, the scenario identifier is associated with a scenario.

The area identifier of the embodiments of this disclosure may be represented in various ways.

For example, integers may be used as identifiers, such as scenario identifiers 1, 2, 3 . . . ;
for another example, a bitmap may be used as an identifier; for example, a bitmap of N bits is used to indicate N scenarios, and the value of N may be determined as actually demanded, for example, N is equal to 8. When a bitmap method is used, more than one scenario may be specified simultaneously;

for a further example, in some embodiments, predefined scenarios may be enumerated by words, and lists, etc., such as “InF (indoor factory)”, and “Uma (urban macrocell)”, etc. ;

for still another example, in some embodiments, scenarios may be specified in other ways, such as specifying wireless channel characteristics, such as “channel NLOS ratio of 60%” and “RSRP>−70 dBm”, which may be characterized by physical quantities defined in protocols, such as “LOS/NLOS indicator”, and “L1-RSRP”, etc.

In some embodiments, the scenario identifier includes a first scenario identifier and a second scenario identifier, the first scenario identifier corresponding to a third area, and the second scenario identifier corresponding to a fourth area.

For example, the third area and the fourth area are different from each other or partially identical or completely identical. In some embodiments, according to a specific definition of the scenario, areas to which different scenario identifiers correspond may be different from each other or partially identical or completely identical. Therefore, data measurement and reporting configuration information to which different scenario identification information corresponds may possibly be completely identical or partially identical or completely different.

In some embodiments, bearer signaling of the scenario identifier may be taken as an optional part of the configuration signaling of the MDT;
in some embodiments, the bearer signaling of the scenario identifier may be an optional part of other configuration signaling of the MDT;
in some embodiments, the bearer signaling of the scenario identifier may be an optional part of the TRACE-related signaling;
in some embodiments, when the second network device is a location management function module (LMF), the bearer signaling of the scenario identifier may be an optional part of the NRPPa-related signaling.

In some embodiments, the bearer signaling of the scenario identifier may be other signaling or a part of other signaling.

In some embodiments, the area identifier and scenario identifier may be used together.

For example, the area identifier includes a first area identifier and a second area identifier, the first area identifier corresponding to the first area, and the second area identifier corresponding to the second area; the scenario identifier includes a first scenario identifier and a second scenario identifier, the first scenario identifier corresponding to the third area, and the second scenario identifier corresponding to the fourth area;

wherein the third area and/or the fourth area is/are different from or partially identical to or completely identical to the first area or the second area.

That is, areas to which the area identifier and the scenario identifier correspond may be different from each other or partially identical or completely identical.

In some embodiments, the second scope information is application information of data collection, the application information being at least one of model identifier (e.g. model ID) information, functionality identifier (e.g. functionality ID) information, and model meta-information.

In some embodiments, the model identifier information is used to distinguish different AI/ML models,
the functionality identifier information is used to distinguish different functions, the functions including at least one of a function defined by an AI/ML application or other functions,
and the model meta-information includes AI/ML model information, the AI/ML model information including data information needed by an AI/ML model.

For example, the AI/ML model information is attribute information of the AI/ML model.

In some embodiments, the model identifier, functionality identifier, model meta-information and other relevant information may include wireless channel characteristics, such as “channel NLOS probability 60%”, and “RSRP>−70dBm”, etc. These characteristics may be characterized by physical quantities defined in the protocols, such as “LOS/NLOS indicator”, and “L1-RSRP”, etc.

In some embodiments, the application information is provided via a model identifier, the model identifier including a model number and other model information, such as model input, model output, a model structure, a model use case, a model performance, and model development information, etc.

In some embodiments, the application information is given via the functionality identifier, the functionality identifier including AI/ML related functionalities, such as model supervision, and model training, etc., and including other functionalities defined by one or more terminal equipment features (UE features).

In some embodiments, the application information is given via the model meta-information, the model meta-information including model input, model output, a model structure, a model use case, a model performance, and model development information, etc.

In some embodiments, the application information corresponds to a data collection requirement.

For example, the model identifier, functionality identifier, model meta-information and other related information are all related to the data collection requirement. In some embodiments, the model input and output contained in the model identifier or model meta-information may be related to a required data sample amount. In some other embodiments, the AI/ML model life cycle management information (such as model supervision) contained in the functionality identifier may be related to accuracy or a transmission delay of the needed data.

In some embodiments, data demand information has an effect on data measurement and reporting. For example, impacts of the different data demand information include measurement contents, measurement periods, reporting contents, and reporting periods.

In some embodiments, the second scope information includes at least first application information and second application information, the first application information corresponding to a first data collection requirement, and the second application information corresponding to a second data collection requirement.

For example, the first data collection requirement and the second data collection requirement are at least one of data quality, data accuracy, a data sample size, a data source, a data type, a data acquisition method, a data acquisition delay, and other requirements.

In some embodiments, the first data collection requirement and the second data collection requirement are completely identical or partially identical or completely different. That is, data collection requirements to which different application information corresponds may be completely identical or partially identical or completely different.

For example, according to specific contents of model identifier and/or functionality identifier and/or model meta-information, requirements of different applications on data collection may be completely identical or partially identical or completely different, and one data or a group (multiple) of data may simultaneously meet requirements of different model identifier and/or functionality identifier and/or model meta-information on data collection.

In some embodiments, bearer signaling of the application information may be taken an optional part of the configuration signaling of the MDT;

in some embodiments, the bearer signaling of the application information may be an optional part of other configuration signaling of the MDT;

in some embodiments, the bearer signaling of the application information may be an optional part of the TRACE-related signaling;

in some embodiments, when the second network device is located in s location management function (LMF) module, the bearer signaling of the application information may be an optional part of the NRPPa-related signaling.

In some embodiments, the bearer signaling of the application information may be other signaling or a part of other signaling.

In some embodiments, the first network device first receives second information from the terminal equipment.

In some embodiments, the second information is related to a terminal capability and/or a terminal preference.

For example, the terminal capability is a capability of the terminal equipment to collect data, including at least one of a capability of the terminal equipment to support a specific measurement content, a capability of the terminal equipment to receive a specific configuration reference signal, a capability of the terminal equipment to acquire a measurement result satisfying specific measurement accuracy, a capability of the terminal equipment to collect a certain number of data samples within a specific time scope, a capability of the terminal equipment to report a certain number of data samples within a specific time scope, a capability of the terminal equipment to evaluate data quality of a measurement result, a capability of the terminal equipment to support a specific model, and support a specific functionality.

For example, the terminal preference is information regarding various aspects of the data collection procedure fed back by the terminal equipment to the first network device during the data collection procedure, and includes whether the terminal equipment is willing to report current measurement data.

In some embodiments, information on the terminal capability and information on the terminal preference may be transmitted simultaneously or separately and independently.

In some embodiments, the second information is transmitted via at least one of RRC, a UAI, a UE capability, a MAC CE, and UCI signaling.

In some embodiments, the second information may be triggered by the first network device via request signaling, or may be reported proactively.

In some embodiments, the first network device receives the second information from the terminal equipment in one or more times.

For example, the terminal equipment may report the second information for one or more times before the data collection procedure begins, or may report the second information for one or more times after the data collection procedure begins.

In some embodiments, the first network device may configure transmission of the second information, such as instructing the terminal equipment to transmit the second information for one or multiple times, wherein implementation of multiple times of transmission may be periodic transmission according to parameters configured by the first network device, or may be indicated by a timer configured by the first network device. Or, the first network device may configure some optional events, and the terminal equipment triggers transmission of the second information when these events occur.

The first configuration information, the first information and the second information are described above in detail.

In operation 201, the first network device generates the second configuration information used to configure measurement and data reporting of the terminal equipment according to the first configuration information received from the second network device and the first information and/or the second information.

In one implementation, the first network device transmits the second configuration information or a part of information in the second configuration information to some terminal equipments satisfying data collection conditions according to the first configuration information and the first information and/or the second information, and does not transmit the second configuration information to terminal equipments not satisfying the data collection conditions.

In another implementation, the first network device transmits the second configuration information to all terminal equipments, the second configuration information including the scope information of data collection. For example, the scope information is application information of data collection, the application information being at least one of model identifier information, functionality identifier information, and model meta-information, and the terminal equipment judges a measurement and reporting scope according to the scope information and determines whether to execute the measurement and reporting procedure.

In addition, the above two implementation methods may coexist. For example, in the first implementation, the first network device transmits second configuration information including the scope information (such as the above application information) to some terminal equipments, and transmits second configuration information including the scope information to some other terminal equipments.

In operation 202, the first network device transmits the second configuration information to the terminal equipment.

In some embodiments, the second configuration information is transmitted via at least one of RRC, a MAC CE, and DCI signaling.

In some embodiments, a transmission mode of the second configuration information includes at least one of the following that:
as an optional part of existing RRC signaling, the second configuration information is transmitted along with existing RRC signaling, the existing RRC signaling including, for example, MeasConfig, or being other existing RRC signaling; and
the second configuration information is transmitted separately not along with existing RRC signaling.

After receiving the second configuration information, the terminal equipment executes the measurement and data reporting procedure according to the second configuration information.

In some embodiments, the data collection procedure includes a data measurement procedure, a data reporting procedure and related signaling.

In some embodiments, the data measurement procedure includes layer 1 measurement, layer 3 measurement, and RRM measurement, etc.

In some embodiments, contents of the data measurement include the contents of measurement included in TS38.215, TS38.133 and TS38.331 protocols.

In some embodiments, the data measurement includes generation, transmission and reception of reference signals and other measurement-related parameter configurations and generation of measurement result-related data, and the data reporting procedure includes generation of reporting parameter configurations and transmission and reception of data or datasets between devices (or entities).

In some embodiments, the data measurement and reporting procedure may be performed at a 3GPP physical layer, such as measurement and reporting of L1-RSRP.

In some embodiments, the data measurement and reporting procedure may be performed at a 3GPP higher layer, such as data measurement and reporting in an MDT framework.

In some embodiments, the configuration information of data measurement and data reporting may be performed separately at a physical layer or a higher layer.

In some embodiments, contents of the data reporting may include measurement results and other related information, such as a data-related timestamp, and data-related quality information, etc.

In some embodiments, data may be reported in a hierarchical manner, such as from a terminal equipment to a base station (first network device), and from a base station to a core network or a higher-layer network (second network devices). Hierarchical reporting may be performed by an intermediate node in a container pass-through manner, or may be different at each level.

In operation 201, the first network device generates the second configuration information according to the first configuration information and the first information received from the second network device; or
the first network device generates the second configuration information according to the first configuration information received from the second network device and the second information received from the terminal equipment; or
the first network device generates the second configuration information according to the first configuration information and the first information received from the second network device and the second information received from the terminal equipment.

Specific examples are given below for different cases.

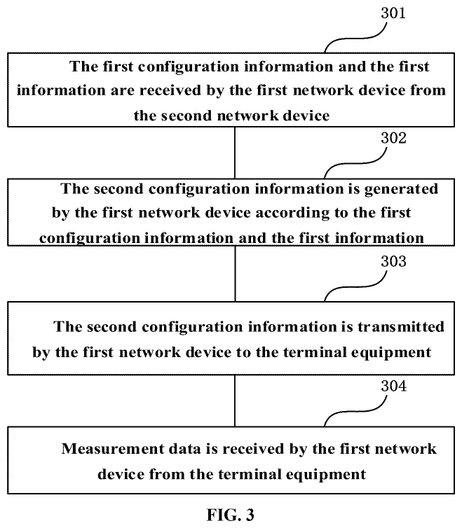

FIG. 3 is a block diagram of an implementation of the method for transmitting and receiving information of the embodiments of this disclosure. As shown in FIG. 3, the method is executed by the first network device and includes:
301: the first configuration information and the first information are received by the first network device from the second network device, wherein the first information may be taken as an optional part and transmitted along with the first configuration information, or it may be transmitted via NGAP signaling and/or other signaling, and not transmitted along with the first configuration information;
302: the second configuration information is generated by the first network device according to the first configuration information and the first information;
303: the second configuration information is transmitted by the first network device to the terminal equipment; and
304: measurement data is received by the first network device from the terminal equipment.

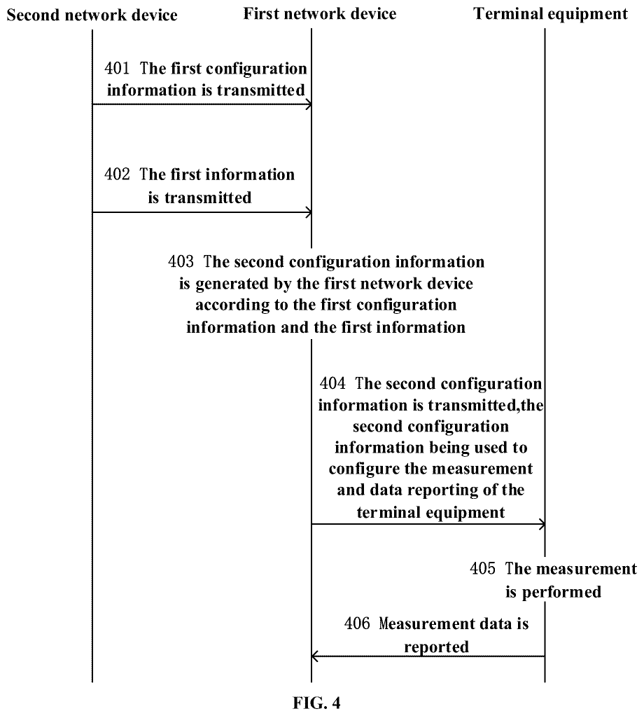

FIG. 4 is an interaction diagram of an implementation of the method for transmitting and receiving information of the embodiments of this disclosure. As shown in FIG. 4, the method includes:
401: the first configuration information is transmitted by the second network device to the first network device;
402: the first information is transmitted by the second network device to the first network device;
403: the second configuration information is generated by the first network device according to the first configuration information and the first information;
404: the second configuration information is transmitted by the first network device to the terminal equipment, the second configuration information being used to configure the measurement and data reporting of the terminal equipment;
405: the measurement is performed by the terminal equipment; and
406: measurement data is reported by the terminal equipment to the first network device.

In some embodiments, operations 401 and 402 may be merged into one operation, that is, the first information is transmitted along with the first configuration information.

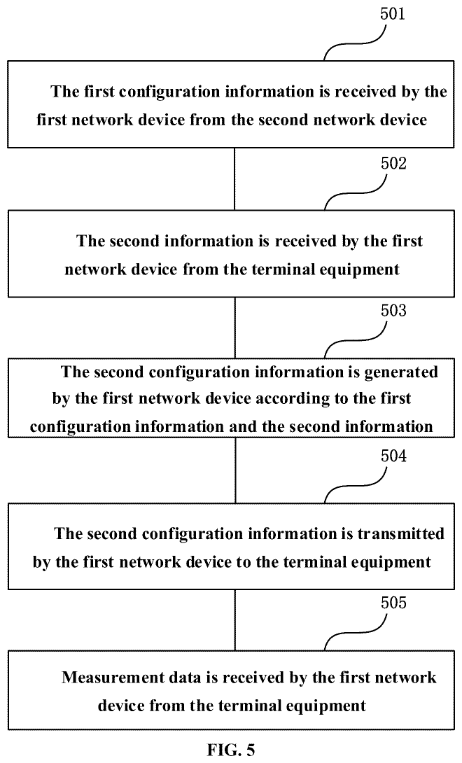

FIG. 5 is a block diagram of another implementation of the method for transmitting and receiving information of the embodiments of this disclosure. As shown in FIG. 5, the method is executed by the first network device and includes:
501: the first configuration information is received by the first network device from the second network device;
502: the second information is received by the first network device from the terminal equipment;
503: the second configuration information is generated by the first network device according to the first configuration information and the second information;
504: the second configuration information is transmitted by the first network device to the terminal equipment; and
505: measurement data is received by the first network device from the terminal equipment.

FIG. 6 is an interaction diagram of another implementation of the method for transmitting and receiving information of the embodiments of this disclosure. As shown in FIG. 6, the method includes:
601: the first configuration information is transmitted by the second network device to the first network device;
602: the second information is transmitted by the terminal equipment to the first network device;
603: the second configuration information is generated by the first network device according to the first configuration information and the second information;
604: the second configuration information is transmitted by the first network device to the terminal equipment, the second configuration information being used to configure the measurement and data reporting of the terminal equipment;
605: the measurement is performed by the terminal equipment; and
606: measurement data is reported by the terminal equipment to the first network device.

In some embodiments, the transmitting of the second information by the terminal equipment to the first network device may be autonomous reporting, or may be triggered by request signaling transmitted by the first network device.

For example, as shown in FIG. 6, before operation 602, the method may further include:
607: request signaling is transmitted by the first network device to the terminal equipment, so as to trigger the terminal equipment to report the second information. Wherein, operation 607 is optional.

In some embodiments, the first network device may also generate the second configuration information according to the first configuration information, the first information and the second information.

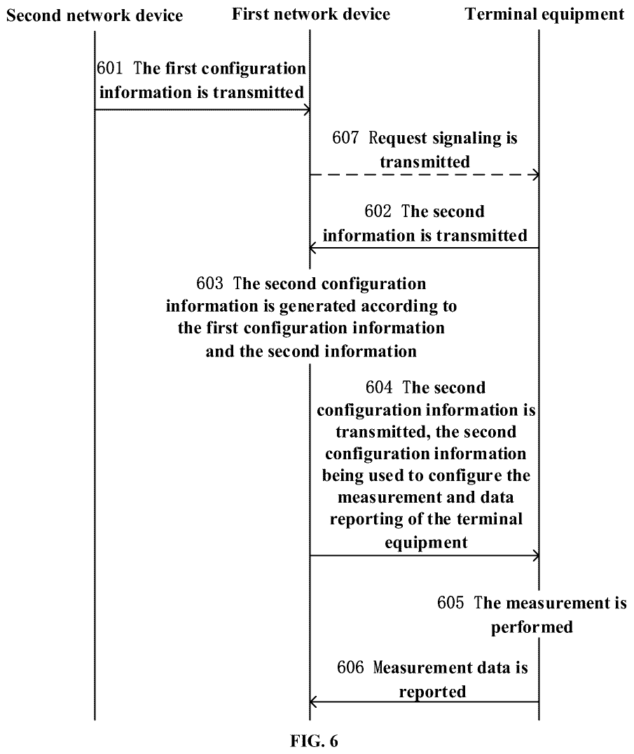

FIG. 7 is an interaction diagram of a further implementation of the method for transmitting and receiving information of the embodiments of this disclosure. As shown in FIG. 7, the method includes:
701: the first configuration information is transmitted by the second network device to the first network device;
702: the first information is transmitted by the second network device to the first network device;
703: the second information is transmitted by the terminal equipment to the first network device;
704: the second configuration information is generated by the first network device according to the first configuration information, the first information and the second information;
705: the second configuration information is transmitted by the first network device to the terminal equipment, the second configuration information being used to configure the measurement and data reporting of the terminal equipment;
706: the measurement is performed by the terminal equipment; and
707: measurement data is reported by the terminal equipment to the first network device.

In some embodiments, operations 701 and 702 may be merged into one operation, that is, the first information is transmitted along with the first configuration information. Furthermore, optionally, the operation of transmitting request signaling by the first network device to the terminal equipment may be performed before operation 703.

The embodiments for the various application scenarios described above are merely illustrative of the embodiments of this disclosure. However, this disclosure is not limited thereto, and appropriate variants may be made on the basis of these application scenarios. For example, the above application scenarios may be executed separately, or one or more of them may be executed in a combined manner.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Second Aspect

The embodiments of this disclosure provide a method for transmitting and receiving information, which shall be described from a terminal equipment side. This embodiment corresponds to the embodiment of the first aspect, and contents in this embodiment identical to those in the embodiment of the first aspect shall not be repeated herein any further.

FIG. 8 is another schematic diagram of the method for transmitting and receiving information of the embodiments of this disclosure. As shown in FIG. 8, the method includes:
801: second configuration information is received by a terminal equipment from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and
802: a measurement and data reporting procedure is performed by the terminal equipment according to the second configuration information.

It should be noted that FIG. 8 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 8.

In some embodiments, the second information is related to a terminal capability and/or a terminal preference.

For example, the terminal capability is a capability of the terminal equipment in a data collection procedure, and includes at least one of a capability of the terminal equipment to support a measurement content, a capability of the terminal equipment to acquire specific measurement accuracy, a capability of the terminal equipment to support a specific model, and a capability of the terminal equipment to support a specific function.

For example, the terminal preference is information regarding various aspects of the data collection procedure fed back by the terminal equipment to the first network device during the data collection procedure, and includes whether the terminal equipment is willing to report current measurement data.

In some embodiments, the terminal equipment transmits the second information to the first network device in one or more times.

In some embodiments, the first network device may configure transmission of the second information, such as instructing the terminal equipment to transmit the second information for one or multiple times, wherein implementation of multiple times of transmission may be periodic transmission according to parameters configured by the first network device, or may be indicated by a timer configured by the first network device. Or, the first network device may configure some optional events, and the terminal equipment triggers transmission of the second information when these events occur.

In some embodiments, the second information is transmitted via at least one of RRC, UAI, a UE capability, a MAC CE, and UCI signaling.

In some embodiments, the second information includes scope information of data collection.

In some embodiments, the second configuration information is transmitted via at least one of RRC, a MAC CE, and DCI signaling.

In some embodiments, a transmission mode of the second configuration information includes at least one of the following that:
as an optional part of existing RRC signaling, the second configuration information is transmitted along with existing RRC signaling; and
the second configuration information is transmitted separately not along with existing RRC signaling.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Third Aspect

The embodiments of this disclosure provides a method for transmitting and receiving information, which shall be described from a second network device side (a core network and/or higher layer network side). This embodiment corresponds to the embodiment of the first aspect, and contents in this embodiment identical to those in the embodiment of the first aspect shall not be repeated herein any further.

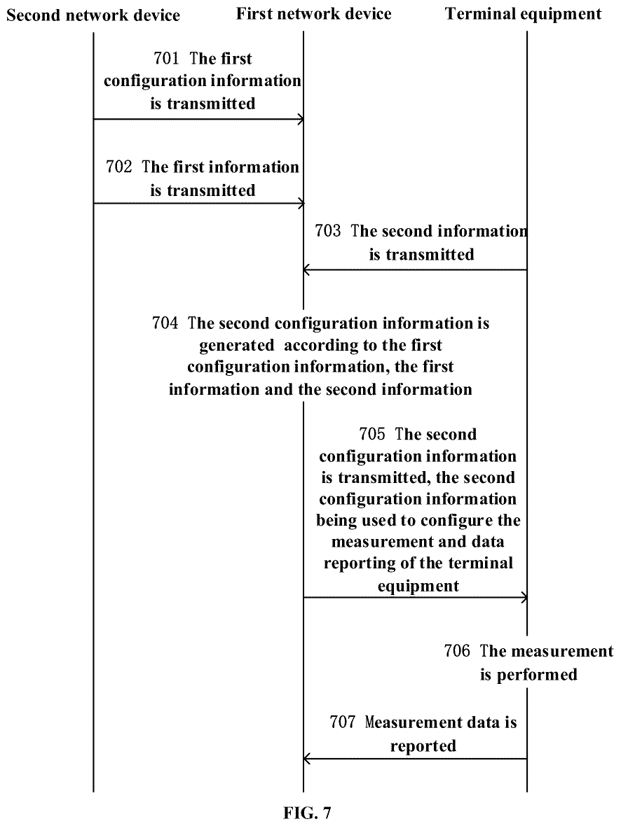

FIG. 9 is a further schematic diagram of the method for transmitting and receiving information of the embodiments of this disclosure. As shown in FIG. 9, the method includes:
901: first configuration information is transmitted by a second network device to a first network device,
wherein the first network device generates second configuration information according to the first configuration information and first information and/or second information, the second configuration information being used to configure measurement and data reporting of a terminal equipment, the first configuration information and the first information being from the second network device, and the second information being from the terminal equipment.

In some embodiments, the first configuration information is minimization of drive test (MDT) configuration information.

In some embodiments, as shown in FIG. 9, the method further includes:
902: the first information is transmitted by the second network device to the first network device.

In some embodiments, a transmission mode of the first information includes at least one of the following that:
as an optional part of the first configuration information, the first information is transmitted along with the first configuration information; and
the first information is transmitted via NGAP signaling and/or other signaling, and not transmitted along with the first configuration information.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Fourth Aspect

The embodiments of this disclosure provide an apparatus for transmitting and receiving information. The apparatus may be, for example, a network device, or one or some components or assemblies configured in the network device. This embodiment corresponds to the embodiment of the first aspect, and contents in this embodiment identical to those in the embodiment of the first aspect shall not be described herein any further.

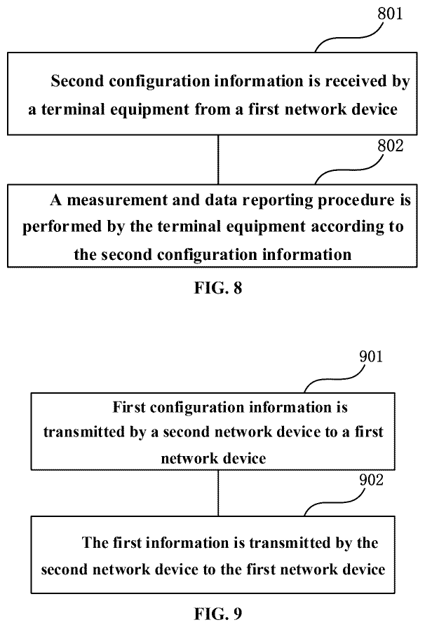

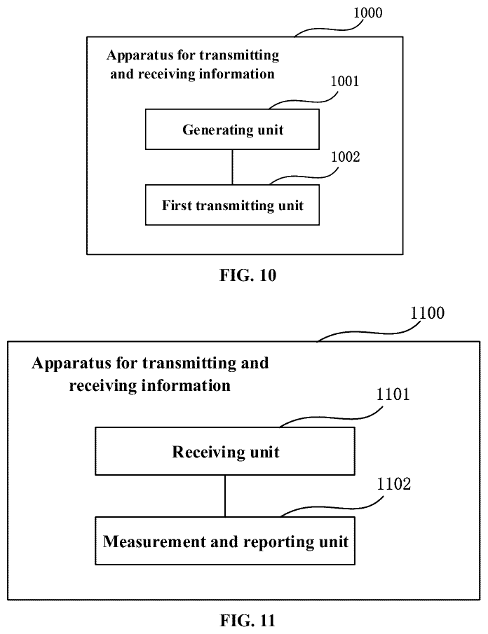

FIG. 10 is a schematic diagram of the apparatus for transmitting and receiving information of the embodiments of this disclosure. As shown in FIG. 10, an apparatus 1000 for transmitting and receiving information includes:
a generating unit 1001 configured to generate second configuration information according to first configuration information and first information and/or second information, the second configuration information being used to configure measurement and data reporting of a terminal equipment, the first configuration information and the first information being from a second network device, and the second information being from the terminal equipment; and
a first transmitting unit 1002 configured to transmit the second configuration information to the terminal equipment.

In some embodiments, the first configuration information is minimization of drive test (MDT) configuration information.

In some embodiments, the first information is related to a data collection scope, and is first scope information and/or second scope information.

In some embodiments, the first scope information indicates an area and/or a zone and/or a region where a data collection procedure is performed.

In some embodiments, the area/zone is/are a part of an area scope, and include(s) a part less than or equal to a cell;
or, the area/zone is/are a part of multiple area scopes;
or, the area/zone is/are all of one or more area scopes.

For example, the area is all or a part of one or more existing area scopes, and a magnitude of the area includes a magnitude less than that of a cell.

Therefore, based on the first information, data collection may be configured more finely. For example, there may exist M areas in a cell according differences in characteristics of wireless channels. For applications of AI/ML wireless positioning models that are sensitive to channel characteristics, data collected only in N (N≤M) areas are effective for the models.

In some embodiments, the first scope information is an area identifier (e.g. an area ID or a zone ID) and/or a scene identifier or scenario identifier (e.g. a scene ID or a scenario ID).

In some embodiments, the area identifier includes a first area identifier and a second area identifier, the first area identifier corresponding to a first area, and the second area identifier corresponding to a second area.

In some embodiments, the scenario identifier is associated with a scenario.

The scenario identifier includes a first scenario identifier and a second scenario identifier, the first scenario identifier corresponding to a third area, and the second scenario identifier corresponding to a fourth area.

In some embodiments, the second scope information is application information of data collection, the application information being at least one of model identifier information, functionality identifier information, and model meta-information.

In some embodiments, the application information corresponds to a data collection requirement.

The second scope information includes at least first application information and second application information, the first application information corresponding to a first data collection requirement, and the second application information corresponding to a second data receipt requirement.

In some embodiments, the first data collection requirement and the second data collection requirement are at least one of data quality, data accuracy, a data sample size, a data source, a data type, a data acquisition method, a data acquisition delay, and other requirements.

In some embodiments, the model identifier information is used to distinguish different AI/ML models,

the functionality identifier information is used to distinguish different functions, the functions including at least one of a function defined by an AI/ML application or other functions,

and the model meta-information includes AI/ML model information, the AI/ML model information including data information needed by an AI/ML model.

In some embodiments, a transmission mode of the first information includes at least one of the following that:
as an optional part of the first configuration information, the first information is transmitted along with the first configuration information; and
the first information is transmitted via NGAP signaling and/or other signaling, and not transmitted along with the first configuration information.

In some embodiments, the second information is related to a terminal capability and/or a terminal preference.

For example, the terminal capability is a capability of the terminal equipment in a data collection procedure, and includes at least one of a capability of the terminal equipment to support a measurement content, a capability of the terminal equipment to acquire specific measurement accuracy, a capability of the terminal equipment to support a specific model, and a capability of the terminal equipment to support a specific function.

For example, the terminal preference is information regarding various aspects of the data collection procedure fed back by the terminal equipment to the first network device during the data collection procedure, and includes whether the terminal equipment is willing to report current measurement data.

In some embodiments, the first network device receives the second information from the terminal equipment in one or more times.

In some embodiments, the first network device may configure transmission of the second information, such as instructing the terminal equipment to transmit the second information for one or multiple times, wherein implementation of multiple times of transmission may be periodic transmission according to parameters configured by the first network device, or may be indicated by a timer configured by the first network device. Or, the first network device may configure some optional events, and the terminal equipment triggers transmission of the second information when these events occur.

In some embodiments, the second configuration information includes scope information of data collection.

The terminal equipment executes the measurement and data reporting procedure according to the second configuration information.

In some embodiments, a transmission mode of the second configuration information includes at least one of the following that:
as an optional part of existing RRC signaling, the second configuration information is transmitted along with existing RRC signaling; and
the second configuration information is transmitted separately not along with existing RRC signaling.

It should be noted that the components or modules related to this disclosure are only described above. However, this disclosure is not limited thereto, and the apparatus 1000 for transmitting and receiving information may further include other components or modules, and reference may be made to related techniques for particulars of these components or modules.

Furthermore, for the sake of simplicity, connection relationships between the components or modules or signal profiles thereof are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Fifth Aspect

The embodiments of this disclosure provide an apparatus for transmitting and receiving information. The apparatus may be, for example, a terminal equipment, or one or some components or assemblies configured in the terminal equipment. This embodiment corresponds to the embodiment of the second aspect, and contents in this embodiment identical to those in the embodiments of the first and second aspects shall not be described herein any further.

FIG. 11 is a schematic diagram of the apparatus for transmitting and receiving information of the embodiments of this disclosure. As shown in FIG. 11, an apparatus 1100 for transmitting and receiving information includes:
a receiving unit 1101 configured to receive second configuration information from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and
a measurement and reporting unit 1102 configured to execute a measurement and data reporting procedure according to the second configuration information.

It should be noted that the components or modules related to this disclosure are only described above. However, this disclosure is not limited thereto, and the apparatus 1100 for transmitting and receiving information may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Sixth Aspect

The embodiments of this disclosure provides an apparatus for transmitting and receiving information. The apparatus may be, for example, a network device, or one or some components or assemblies configured in the network device. This embodiment corresponds to the embodiment of the third aspect, and contents in this embodiment identical to those in the embodiments of the third and first aspects shall not be described herein any further.

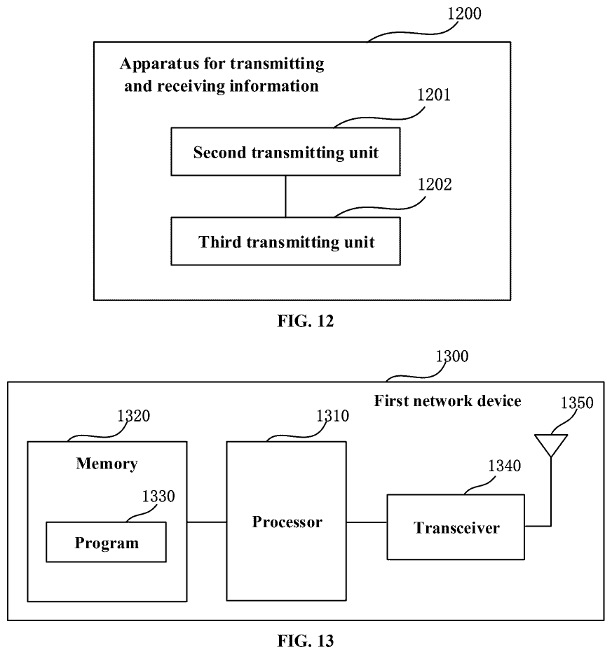

FIG. 12 is a schematic diagram of the apparatus for transmitting and receiving information of the embodiments of this disclosure. As shown in FIG. 12, an apparatus 1200 for transmitting and receiving information includes:
a second transmitting unit 1201 configured to transmit first configuration information to the first network device,
wherein the first network device generates second configuration information according to the first configuration information and first information and/or second information, the second configuration information being used to configure measurement and data reporting of a terminal equipment, the first configuration information and the first information being from the second network device, and the second information being from the terminal equipment.

In some embodiments, as shown in FIG. 12, the apparatus 1200 for transmitting and receiving information further includes:
a third transmitting unit 1202 configured to transmit first information to the first network device.

It should be noted that the components or modules related to this disclosure are only described above. However, this disclosure is not limited thereto, and the apparatus 1200 for transmitting and receiving information may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Seventh Aspect

The embodiments of this disclosure provides a network device, including the apparatus for transmitting and receiving information described in the embodiment of the fifth aspect. The network device is a first network device.

FIG. 13 is a block diagram of a systematic structure of the first network device of the embodiments of this disclosure. As shown in FIG. 13, a first network device 1300 may include a processor 1310 and a memory 1320, the memory 1320 being coupled to the processor 1310. Wherein, the memory 1320 may store various data, and furthermore, it may store a program 1330 for information processing, and execute the program 1330 under control of the processor 1310.

In one implementation, functions of the apparatus for transmitting and receiving information may be integrated into the processor 1310.

The processor 1310 may be configured to: generate second configuration information according to first configuration information and first information and/or second information, the second configuration information being used to configure measurement and data reporting of a terminal equipment, the first configuration information and the first information being from a second network device, and the second information being from the terminal equipment; and transmit the second configuration information to the terminal equipment.

In another implementation, the apparatus for transmitting and receiving information and the processor 1310 may be configured separately; for example, the apparatus for transmitting and receiving information may be configured as a chip connected to the processor 1310, and the functions of the apparatus for transmitting and receiving information are executed under control of the processor 1310.

Furthermore, as shown in FIG. 13, the first network device 1300 may include a transceiver 1340, and an antenna 1350, etc. Wherein, functions of the above components are similar to those in the related art, and shall not be described herein any further. It should be noted that the first network device 1300 does not necessarily include all the parts shown in FIG. 13, and furthermore, the first network device 1300 may include parts not shown in FIG. 13, and the related art may be referred to.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of an Eighth Aspect

The embodiments of this disclosure provide a terminal equipment, including the apparatus for transmitting and receiving information described in the embodiment of the fifth aspect.

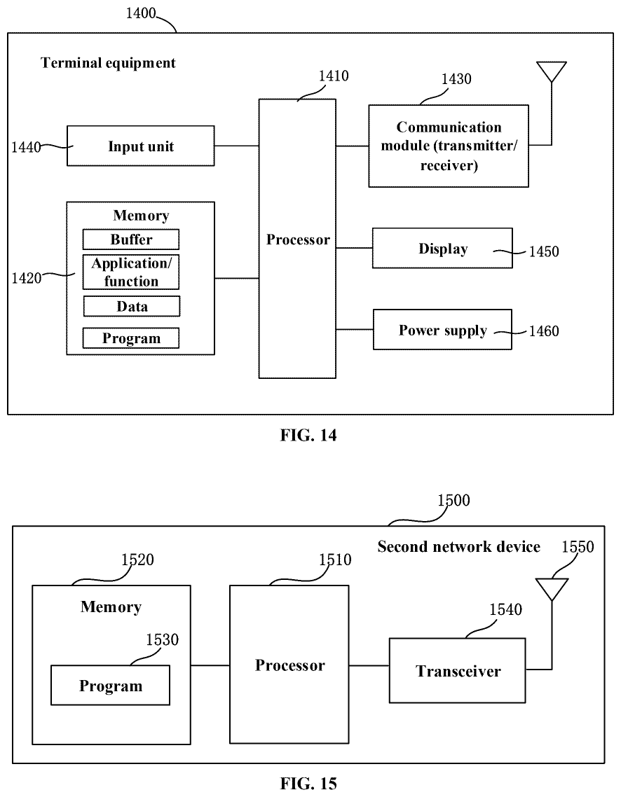

FIG. 14 is a schematic diagram of a systematic structure of the terminal equipment of the embodiments of this disclosure. As shown in FIG. 14, a terminal equipment 1400 may include a processor 1410 and a memory 1420, the memory 1420 being coupled to the processor 1410. It should be noted that this figure is illustrative only, and other types of structures may also be used, so as to supplement or replace this structure and achieve a telecommunications function or other functions.

In one implementation, the functions of the apparatus for transmitting and receiving information may be integrated into the processor 1410.

The processor 1410 is configured to: receive second configuration information from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and execute a measurement and data reporting procedure according to the second configuration information.

In another implementation, the apparatus for transmitting and receiving information and the processor 1410 may be configured separately; for example, the apparatus for transmitting and receiving information may be configured as a chip connected to the processor 1410, and the functions of the apparatus for transmitting and receiving information are executed under control of the processor 1410.

As shown in FIG. 14, the terminal equipment 1400 may further include a communication module 1430, an input unit 1440, a display 1450, and a power supply 1460. It should be noted that the terminal equipment 1400 does not necessarily include all the parts shown in FIG. 14, and the above components are not necessary. Furthermore, the terminal equipment 1400 may include parts not shown in FIG. 14, and the related art may be referred to.

As shown in FIG. 14, the processor 1410 is sometimes referred to as a controller or an operational control, which may include a microprocessor or other processor devices and/or logic devices. The processor 1410 receives input and controls operations of components of the terminal equipment 1400.

Wherein, the memory 1420 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1410 may execute programs stored in the memory 1420, so as to realize information storage or processing, etc. Functions of other parts are similar to those of the related art, which shall not be described herein any further. The parts of the terminal equipment 1400 may be realized by specific hardware, firmware, software, or any combination thereof, without departing from the scope of this disclosure.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Ninth Aspect

The embodiments of this disclosure provide a network device, including the apparatus for transmitting and receiving information described in the embodiment of the sixth aspect. The network device is a second network device.

FIG. 15 is a block diagram of a systematic structure of the second network device of the embodiments of this disclosure. As shown in FIG. 15, a second network device 1500 may include a processor 1510 and a memory 1520, the memory 1520 being coupled to the processor 1510. Wherein, the memory 1520 may store various data, and furthermore, it may store a program 1530 for information processing, and execute the program 1530 under control of the processor 1510.

In one implementation, functions of the apparatus for transmitting and receiving information may be integrated into the processor 1510.

The processor 1510 may be configured to: transmit first configuration information to the first network device, so that the first network device generates second configuration information according to the first configuration information and first information and/or second information, the second configuration information being used to configure measurement and data reporting of a terminal equipment, the first configuration information and the first information being from the second network device, and the second information being from the terminal equipment.

In another implementation, the apparatus for transmitting and receiving information and the processor 1510 may be configured separately; for example, the apparatus for transmitting and receiving information may be configured as a chip connected to the processor 1510, and the functions of the apparatus for transmitting and receiving information are executed under control of the processor 1510.

Furthermore, as shown in FIG. 15, the second network device 1500 may include a transceiver 1540, and an antenna 1550, etc. Wherein, functions of the above components are similar to those in the related art, and shall not be described herein any further. It should be noted that the second network device 1500 does not necessarily include all the parts shown in FIG. 15, and furthermore, the second network device 1500 may include parts not shown in FIG. 15, and the related art may be referred to.

It can be seen from the above embodiment that according to existing configuration information from the second network device in a core network and/or a higher layer network and additional information, i.e. the first information from the second network device and/or second information from the terminal equipment, etc., the first network device generates the second configuration information for configuring measurement and data reporting of the terminal equipment and transmits it to the terminal equipment, which may generate the second configuration information for configuring measurement and data reporting of the terminal equipment based on more information on the basis of the existing configuration information. Therefore, a terminal equipment that satisfies data collection conditions may be selected and the measurement and data reporting of the terminal equipment may be configured, which is applicable to various application scenarios and use cases having relatively precise and flexible configuration requirements for data collection, thereby achieving optimization of the data collection procedure.

### Embodiment of a Tenth Aspect

The embodiments of this disclosure provides a communication system, including at least one of the network device as described in the embodiment of the seventh aspect, the terminal equipment as described in the embodiment of the eighth aspect and the network device as described in the embodiment of the ninth aspect.

For example, reference may be made to FIG. 1 for a structure of the communication system.

As shown in FIG. 1, the communication system 100 includes the first network device 101, the second network device 102 and the terminal equipment 103. The first network device 101 is identical to the network device described in the embodiment of the seventh aspect, the terminal equipment 103 is identical to the terminal equipment described in the embodiment of the eighth aspect, and the second network device 102 is identical to the network device described in the embodiment of the ninth aspect, with repeated contents being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 10 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 12 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to the implementations including the above embodiments, following supplements are further disclosed.
1. A method for transmitting and receiving information, the method including:
generating second configuration information by a first network device according to first configuration information and first information and/or second information, the second configuration information being used to configure measurement and data reporting of a terminal equipment, the first configuration information and the first information being from a second network device, and the second information being from the terminal equipment; and
transmitting the second configuration information by the first network device to the terminal equipment.
2. The method according to supplement 1, wherein,
the first configuration information is minimization of drive test (MDT) configuration information or configuration information in other scenarios where measurement and data reporting are applied.
3. The method according to supplement 1, wherein,
the first information is related to a data collection scope, and is first scope information and/or second scope information.
4. The method according to supplement 3, wherein,
the first scope information indicates an area and/or a zone and/or a region where a data collection procedure is performed.
5. The method according to supplement 4, wherein,
the area/zone is a part of an area scope, and includes a part less than or equal to a cell;
or, the area/zone is a part of multiple area scopes;
or, the area/zone is all of one or more area scopes.
6. The method according to supplement 4, wherein,
the first scope information is an area identifier and/or a scenario identifier.
7. The method according to supplement 6, wherein,
the area identifier includes a first area identifier and a second area identifier, the first area identifier corresponding to a first area, and the second area identifier corresponding to a second area.
8. The method according to supplement 6, wherein,
the scenario identifier is associated with a scenario,
and the scenario identifier includes a first scenario identifier and a second scenario identifier, the first scenario identifier corresponding to a third area, and the second scenario identifier corresponding to a fourth area.
9. The method according to supplement 7 or 8, wherein,
the first area and the second area are different from each other, or,
the third area and the fourth area are different from each other or partially identical, or,
the third area and/or the fourth area and the first area or the second area are different from each other or partially identical or completely identical.
10. The method according to supplement 3, wherein,
the second scope information is application information of data collection, the application information being at least one of model identifier information, functionality identifier information, and model meta-information.
11. The method according to supplement 10, wherein,
the application information corresponds to a data collection requirement,
and the second scope information includes at least first application information and second application information, the first application information corresponding to a first data collection requirement, and the second application information corresponding to a second data receipt requirement.
12. The method according to supplement 11, wherein,
the first data collection requirement and the second data collection requirement are at least one of data quality, data accuracy, a data sample size, a data source, a data type, a data acquisition method, a data acquisition delay, and other requirements.
13. The method according to supplement 11 or 12, wherein,
the first data collection requirement and the second data collection requirement are completely identical or partially identical or completely different.
14. The method according to supplement 10, wherein,
the model identifier information is used to distinguish different AI/ML models,
the functionality identifier information is used to distinguish different functionalities, the functionalities including at least one of the functions defined by an AI/ML application or other functions,
and the model meta-information includes AI/ML model information, the AI/ML model information including data information needed by an AI/ML model.
15. The method according to any one of supplements 1-14, wherein,
a transmission mode of the first information includes at least one of the following that:
as an optional part of the first configuration information, the first information is transmitted along with the first configuration information; and
the first information is transmitted via NGAP signaling and/or other signaling, and not transmitted along with the first configuration information.
16. The method according to supplement 1, wherein,
the second information is related to a terminal capability and/or a terminal preference.
17. The method according to supplement 16, wherein,
the terminal capability is a capability of the terminal equipment in a data collection procedure, and includes at least one of a capability of the terminal equipment to support a measurement content, a capability of the terminal equipment to acquire specific measurement accuracy, a capability of the terminal equipment to support a specific model, and a capability of the terminal equipment to support a specific function.
18. The method according to supplement 16, wherein,
the terminal preference is information regarding various aspects of the data collection procedure fed back by the terminal equipment to the first network device during the data collection procedure, and includes whether the terminal equipment is willing to report current measurement data.
19. The method according to any one of supplements 1 and 16-18, wherein,
the first network device receives the second information from the terminal equipment in one or more times.
20. The method according to any one of supplements 1 and 16-19, wherein,
the second information is transmitted via at least one of RRC, a UAI, a UE capability, a MAC CE, and UCI signaling.
21. The method according to any one of supplements 1-20, wherein,
the second configuration information includes scope information of data collection,
and the terminal equipment performs the measurement and data reporting procedure according to the second configuration information.
22. The method according to supplement 1 or 21, wherein,
the second configuration information is transmitted via at least one of RRC, a MAC CE, and DCI signaling.
23. The method according to any one of supplements 1 and 20-22, wherein,
a transmission mode of the second configuration information includes at least one of the following that:
as an optional part of existing RRC signaling, the second configuration information is transmitted along with existing RRC signaling; and
the second configuration information is transmitted separately, and not transmitted along with existing RRC signaling.
24. The method according to supplement 20, wherein,
the existing RRC signaling includes MeasConfig.
25. A method for transmitting and receiving information, the method including:
receiving second configuration information by a terminal equipment from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and
performing a measurement and data reporting procedure according to the second configuration information.
26. The method according to supplement 25, wherein,
the second information is related to a terminal capability and/or a terminal preference.
27. The method according to supplement 26, wherein,
the terminal capability is a capability of the terminal equipment in a data collection procedure, and includes at least one of a capability of the terminal equipment to support a measurement content, a capability of the terminal equipment to acquire specific measurement accuracy, a capability of the terminal equipment to support a specific model, and a capability of the terminal equipment to support a specific function.
28. The method according to supplement 26, wherein,
the terminal preference is information regarding various aspects of the data collection procedure fed back by the terminal equipment to the first network device during the data collection procedure, and includes whether the terminal equipment is willing to report current measurement data.
29. The method according to any one of supplements 25-28, wherein,
the terminal equipment transmits the second information to the first network device in one or more times.
30. The method according to any one of supplements 25-29, wherein,
the second information is transmitted via at least one of RRC, a UAI, a UE capability, a MAC CE, and UCI signaling.
31. The method according to any one of supplements 25-30, wherein,
the second configuration information includes scope information of data collection.
32. The method according to supplement 25 or 31, wherein,
the second configuration information is transmitted via at least one of RRC, a MAC CE, and DCI signaling.
33. The method according to any one of supplements 25-32, wherein,
a transmission mode of the second configuration information includes at least one of the following that:
as an optional part of existing RRC signaling, the second configuration information is transmitted along with existing RRC signaling; and
the second configuration information is transmitted separately, and not transmitted along with existing RRC signaling.
34. A method for transmitting and receiving information, the method including:
transmitting first configuration information by a second network device to a first network device, so that the first network device generates second configuration information according to the first configuration information and first information and/or second information, the second configuration information being used to configure measurement and data reporting of a terminal equipment, the first configuration information and the first information being from the second network device, and the second information being from the terminal equipment.
35. The method according to supplement 34, wherein,
the first configuration information is minimization of drive test (MDT) configuration information or configuration information in other scenarios where measurement and data reporting are applied.
36. The method according to supplement 34, wherein the method further includes:
transmitting first information by the second network device to the first network device.
37. The method according to supplement 36, wherein,
a transmission mode of the first information includes at least one of the following that:
as an optional part of the first configuration information, the first information is transmitted along with the first configuration information; and
the first information is transmitted via NGAP signaling and/or other signaling, and not transmitted along with the first configuration information.
38. A network device, including a memory and a processor, the memory storing a computer program, and the processor being configured to execute the computer program to implement the method as described in any one of supplements 1-24.
39. A terminal equipment, including a memory and a processor, the memory storing a computer program, and the processor being configured to execute the computer program to implement the method as described in any one of supplements 25-33.
40. A network device, including a memory and a processor, the memory storing a computer program, and the processor being configured to execute the computer program to implement the method as described in any one of supplements 34-37.
41. A communication system, including at least one of the network device as described in supplement 38, the terminal equipment as described in supplement 39 and the network device as described in supplement 40.

1. An apparatus for transmitting and receiving information, configured in a first network device, the apparatus comprising:
a generator configured to generate second configuration information according to first configuration information and first information and/or second information, the second configuration information being used to configure measurement and data reporting of a terminal equipment, the first configuration information and the first information being from a second network device, and the second information being from the terminal equipment; and
a first transmitter configured to transmit the second configuration information to the terminal equipment.

2. The apparatus according to claim 1, wherein,
the first information is related to a data collection scope, and the first information is first scope information or second scope information.

3. The apparatus according to claim 2, wherein,
the first scope information indicates an area and/or a zone and/or a region where a data collection procedure is performed.

4. The apparatus according to claim 3, wherein
the area is a part of an area scope, and the area includes a part less than or equal to a cell; or
the area is a part of multiple area scopes; or
the area is all of one or more area scopes.

5. The apparatus according to claim 3, wherein,
the first scope information is an area identifier and/or a scenario identifier.

6. The apparatus according to claim 5, wherein,
the area identifier comprises a first area identifier and a second area identifier, the first area identifier corresponding to a first area, and the second area identifier corresponding to a second area.

7. The apparatus according to claim 5, wherein,
the scenario identifier is related to a scenario, and
the scenario identifier comprises a first scenario identifier and a second scenario identifier, the first scenario identifier corresponding to a third area, and the second scenario identifier corresponding to a fourth area.

8. The apparatus according to claim 2, wherein,
the second scope information is application information of data collection, the application information being at least one of model identifier (model ID) information, functionality identifier (functionality ID) information, or model meta-information.

9. The apparatus according to claim 8, wherein,
the application information corresponds to a data collection requirement, and
the second scope information at least comprises first application information and second application information, the first application information corresponding to a first data collection requirement, and the second application information corresponding to a second data collection requirement.

10. The apparatus according to claim 9, wherein,
the first data collection requirement and the second data collection requirement are at least one of data quality, data accuracy, a data sample size, a data source, a data type, a data acquisition method, a data acquisition delay, or other requirements.

11. The apparatus according to claim 8, wherein,
the model identifier information is used to distinguish different AI/ML models,
the functionality identifier information is used to distinguish different functions, the functions comprising at least one of a function defined by an AI/ML application or other functions, and
the model meta-information comprises AI/ML model information, the AI/ML model information comprising data information needed by an AI/ML model.

12. The apparatus according to claim 1, wherein,
a transmission mode of the first information comprises at least one of the following that:
as an optional part of the first configuration information, the first information is transmitted along with the first configuration information; and
the first information is transmitted via NGAP signaling and/or other signaling, and not transmitted along with the first configuration information.

13. The apparatus according to claim 1, wherein, the second information is related to a terminal capability and/or a terminal preference.

14. The apparatus according to claim 13, wherein,
the terminal capability is a capability of the terminal equipment in a data collection procedure, and comprises at least one of a capability of the terminal equipment to support a measurement content, a capability of the terminal equipment to acquire specific measurement accuracy, a capability of the terminal equipment to support a specific model, or a capability of the terminal equipment to support a specific function, and/or,
the terminal preference is information regarding various aspects of the data collection procedure fed back by the terminal equipment to the first network device during the data collection procedure, and comprises whether the terminal equipment is willing to report current measurement data.

15. The apparatus according to claim 1, wherein,
the first network device receives the second information from the terminal equipment in one or more times.

16. The apparatus according to claim 1, wherein,
the second configuration information comprises scope information of data collection, and
the terminal equipment performs a measurement and data reporting procedure according to the second configuration information.

17. The apparatus according to claim 1, wherein,
a transmission mode of the second configuration information comprises at least one of the following that:
as an optional part of existing RRC signaling, the second configuration information is transmitted along with existing RRC signaling; and
the second configuration information is transmitted separately, and not transmitted along with existing RRC signaling.

18. The apparatus according to claim 1, wherein,
the first configuration information is minimization of drive test (MDT) configuration information or configuration information in other scenarios where measurement and data reporting are applied.

19. An apparatus for transmitting and receiving information, configured in a terminal equipment, the apparatus comprising:
a receiver configured to receive second configuration information from a first network device, the second configuration information being generated according to first configuration information and first information and/or second information, the second configuration information being used to configure measurement and data reporting of the terminal equipment, the first configuration information and the first information being from a second network device, and the second information being from the terminal equipment; and
measurement and reporting processor circuitry configured to perform a measurement and data reporting procedure according to the second configuration information.

20. An apparatus for transmitting and receiving information, configured in a second network device, the apparatus comprising:
a second transmitter configured to transmit first configuration information to a first network device, so that the first network device generates second configuration information according to the first configuration information and first information and/or second information, the second configuration information being used to configure measurement and data reporting of a terminal equipment, the first configuration information and the first information being from the second network device, and the second information being from the terminal equipment.
